(19) United States
(12) Patent Application Publication
(10) Pub. No.: US 2005/0242313 A1
(43) Pub. Date: Nov. 3, 2005

(54) Apparatus for controlling medium flow

(75) Inventor: Harri Kronholm, Tampere (FI)

Correspondence Address: BIRCH STEWART KOLASCH & BIRCH, PO BOX 747, FALLS CHURCH, VA, 22040-0747, US

(73) Assignee: VAAHTO OY, Hollola (FI)

(21) Appl. No.: 11/117,604

(22) Filed: Apr. 29, 2005

(30) Foreign Application Priority Data
Apr. 30, 2004 (FI) 20040625

(51) Int. Cl. F16K 47/00

(52) U.S. Cl. 251/124

(57) ABSTRACT

An apparatus for controlling medium flow, especially for controlling dilution liquid flow in connection with the headbox of a paper-making machine or a cardboard-manufacturing machine, which apparatus comprises a valve which controls dilution flow, which valve consists of a valve housing (1), a stem part (4) and a flow channel between an inlet (2) and an outlet (3) of the valve. The stem part (4) is movable in the housing between at least two positions, a first position in which the flow path between the inlet and the outlet is open, and a second position in which the flow path is closed, and the stem part (4) and/or housing is designed to direct the medium flow at least in the vicinity of the outlet opening.

### BACKGROUND OF THE INVENTION

The invention relates to an apparatus for controlling medium flow, as defined in the preamble of claim 1, especially for controlling dilution liquid flow in connection with the headbox of a paper-making machine or a cardboard-manufacturing machine, which apparatus comprises a valve which controls dilution flow, which valve consists of a valve housing, a stem part and a flow channel between an inlet and an outlet of the valve.

Dilution valves are utilised for controlling the flow of dilution liquid to stock flow. Dilution flow may be clean or fibre-bearing water. Dilution water may be, for example, tail water taken from the web as retention. Solutions are known in which, a rotatable valve stem is used in the dilution valve which stem may be rotatable to different control positions for controlling the dilution flow starting from the valve. Such solution is presented in, inter alia, specification FI110879B. However, different problems occur in these solutions. Because there is fines included in the tail water, there is a strong possibility of the valve stem getting blocked in the rotatable valve, especially when dilution water reaches between the stem and the valve body. Such solutions require an extremely strong actuator to rotate the stem. In addition, frequent so-called wash moving of the stem is typically required in order to prevent the blocking of the stem. In addition, the solution requires utilising extremely precise tolerances, whereby the solution becomes manufacturing-technically demanding and expensive to manufacture. Typically, the solution requisites utilising an actuator adapted for the use in question, which frequently increases costs. Furthermore, the flow range of the dilution valves in question is fixed. Equivalent problems occur also in a solution presented in specification FI100895B, in which the flow path is formed to the stem which is moved to and fro, and in which the choke is controlled on the side of the valve inlet.

The object of this invention is to achieve a totally novel solution for a dilution valve, whereby the disadvantages of known prior-art are avoided.

### BRIEF DESCRIPTION OF THE INVENTION

It is characteristic for the apparatus according to the invention that the stem part is movable in the housing between at least two positions, a first position in which the flow path between the inlet and the outlet is open, and a second position in which the flow path is closed, and that the stem part and/or housing is designed to direct the medium flow at least in the vicinity of the outlet opening.

In addition, the apparatus according to the invention is characterised by what is stated in claims 2-9.

The solution according to the invention has numerous significant advantages. The dilution valve according to the invention does not get blocked. No great forces are required for moving the valve stem. Common actuators available from several different manufacturers may be easily adapted for the valve actuator. With this solution, contamination and valve leaks are easily avoided. This solution does not require precise tolerances. The flow range may be altered by utilising a replaceable mixing sleeve. The pressure loss accomplished with the design of a mixing zone prevents a so-called flow phenomenon. With the design of the mixing zone parts, it is possible to decrease the forming of flocks and, on the other hand, to break the flocks formed. By replacing the mixing sleeve, it is possible to enlarge or reduce the flow range. By using a to-and-fro linear movement for moving the stem, easy compactability and light, small-force-requiring moving are again achieved. From this results also ease of manufacturing because the structure does not require precise tolerances.

### BRIEF DESCRIPTION OF THE FIGURES

In the following, the invention will be described in detail by means of an example with reference to the accompanying drawing, wherein

FIG. 1 presents an apparatus according to the invention as a cross section with the stem in a first position,

FIG. 2 presents an apparatus according to the invention as a cross section with the stem in a second position,

FIG. 3 presents an apparatus according to the invention together with an actuator,

FIG. 4 presents a part of the apparatus according to the invention in more detail in a different scale,

FIG. 5 presents a second part of the apparatus according to the invention in more detail in a different scale, and

FIG. 6 presents a part of FIG. 5 together with a third part according to the invention in a different scale.

### DETAILED DESCRIPTION OF THE INVENTION

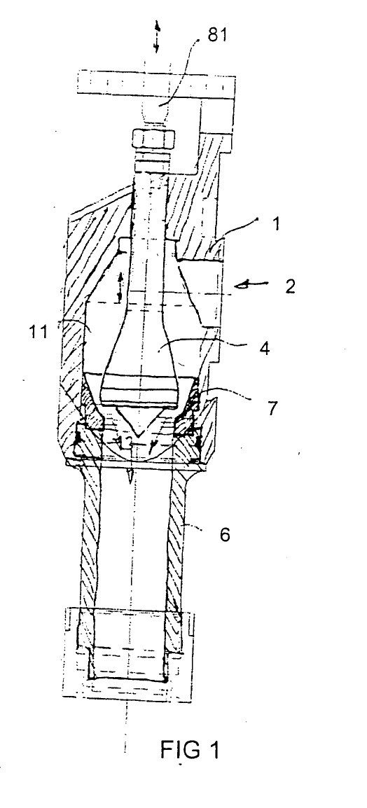

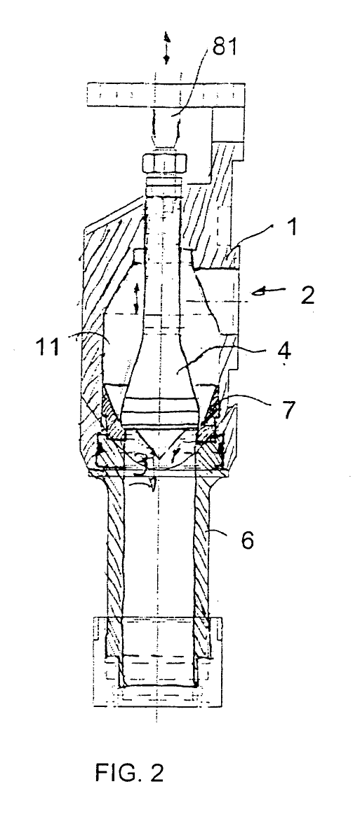

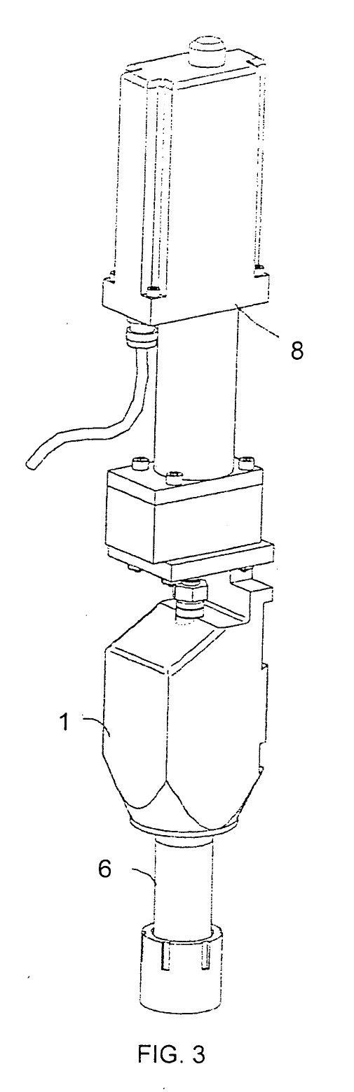

FIGS. 1 and 2 present an apparatus according to the invention in cross-section. The apparatus comprises a dilution valve housing, that is, body part 1 which has an inlet 2. The housing, that is, the body part comprises a chamber area 11, into which there is a flow path from the inlet 2. On the other hand, from the chamber area 11 is arranged an outlet 3. To the housing is arranged movably a stem part 4 which is movable between at least two positions, a first position in which the flow path to the outlet 3 is open, and a second position in which the flow path to the outlet 3 is closed. Typically, between the first and the second position there may be several intermediate positions, whereby the choke of the flow path may be controlled. The stem part is moved with an actuator 8 (FIG. 3). Depending on the type of the actuator 8, the control may be stepless or stepped. The actuator may be any one actuator intended for linear to-and-fro control, such as a pressure-medium-operated piston-cylinder combination or a mechanical motion screw which is operated with an actuator, such as an electric motor.

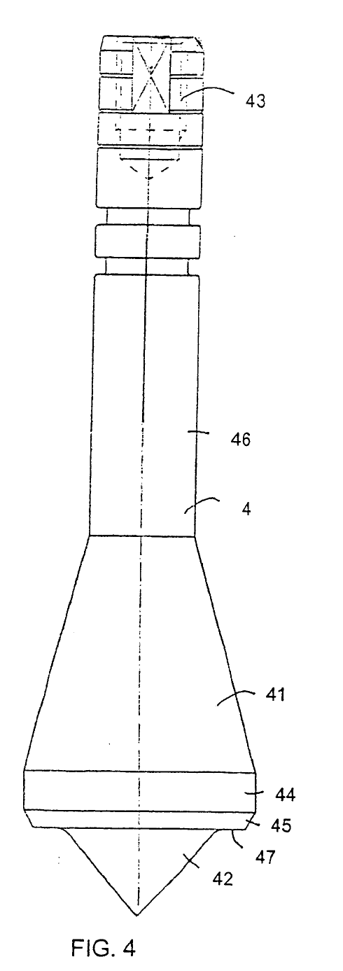

A stem part 4 according to an embodiment of the invention is presented in detail in FIG. 4. In the figure, the stem part 4 comprises a first end 42 which is towards the outlet (in FIG. 1), and a second end 43 from which the stem part is fastened to the actuator, for example, through a fastening means. The stem part comprises an abutment surface 45 for a valve sealing surface 72. The stem part has an extending cone surface 41 which extends towards the first end. Between the extending cone surface 41 and the first end is first a cylinder surface 44, and following that, a tapering cone surface 45 and a transversal surface 47 in respect of the longitudinal axis of the stem. Following this, the stem part has a cone-like tip part 42. The extending cone part 41 is typically in the area between the inlet and the outlet of the valve. The cone-like tip part 42 is typically after the outlet opening 3.

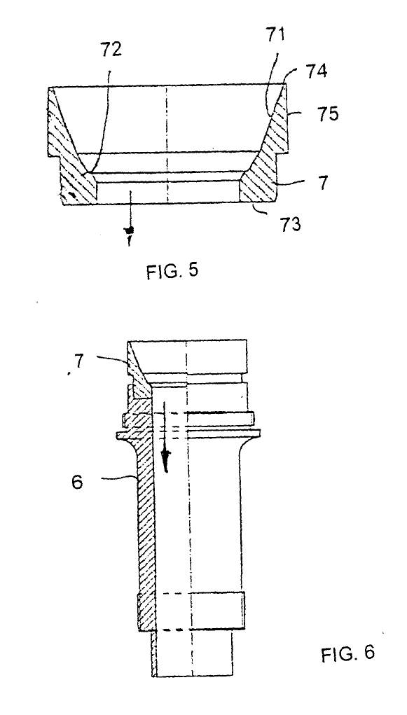

To the chamber area 11, typically in the vicinity of the outlet 3, may be arranged a sleeve member 7. The sleeve member 7 is adapted to function together with the stem part 4, typically as its counterpart. The sleeve member 7 comprises a counter surface 71, 72 for the surface of the stem part. The sleeve member is a so-called mixing ring with which the flow may be deflected towards the stem part, especially towards the tip part 42 of the stem part. The sleeve member 7 is advantageously a replaceable part, whereby the characteristics of the valve member, such as flow characteristics, may be adapted depending on the use. According to FIG. 5, the diameter of the sleeve-member inner surface 71 is tapering from its first end 74 towards the second end 73 and thus towards the outlet. The sleeve 7 may be arranged to be fastened to the valve body, together with an outlet pipe 6. FIG. 6 presents a combination of the sleeve member 7 and the outlet pipe 6. The inner surface of the sleeve member deflects the medium flow towards the stem, whereby the medium flow impacts most advantageously the tip part of the stem which breaks the possible flocks in the flow medium.

Thus, the invention relates to an apparatus for controlling medium flow, especially for controlling dilution liquid flow in connection with the headbox of a paper-making machine or a cardboard-manufacturing machine, which apparatus comprises a valve which controls dilution flow, which valve consists of a valve housing 1, a stem part 4 and a flow channel between an inlet 2 and an outlet 3 of the valve. The stem part 4 is movable in the housing between at least two positions, a first position in which the flow path between the inlet and the outlet is open, and a second position in which the flow path is closed, and the stem part 4 and/or housing is designed to direct the medium flow at least in the vicinity of the outlet opening.

The stem part 4 and/or the housing 1 is designed or arranged to mix the medium flow. To the apparatus is arranged a sleeve member 7 which constitutes at least a part of an abutment surface to the stem part 4. The sleeve member 7 is arranged to the housing to the outlet opening 3 or its vicinity. The sleeve member 7 comprises a surface 71, 72 which deflects the medium flow.

The stem part 4 comprises in the first end, on the side of the outlet, a tip part 42. According to an embodiment of the invention, the stem part 4 comprises also advantageously an extending part 41, which is most advantageously arranged in the stem part to the portion between the valve inlet 2 and the stem tip part 42.

The sleeve member 7 is replaceable, whereby its design may be adapted according to the target of application. The sleeve member 7 is arranged to be fastened to the housing 1 together with the outlet pipe 6.

It is obvious to those skilled in the art that the invention is not limited to the embodiments described above, but it may be varied within the scope of the enclosed claims. If required, the characteristic features possibly described in this specification together with other characteristic features may also be used separate from each other.

1. An apparatus for controlling medium flow, especially for controlling dilution liquid flow in connection with the headbox of a paper-making machine or a cardboard-manufacturing machine, which apparatus comprises a valve which controls dilution flow, which valve comprises of a valve housing (1), a stem part (4) and a flow channel between an inlet (2) and an outlet (3) of the valve, characterised in that the stem part (4) is movable in the housing between at least two positions, a first position in which the flow path between the inlet and the outlet is open, and a second position in which the flow path is closed, and that the stem part (4) and/or housing is designed to direct the medium flow at least in the vicinity of the outlet opening.

2. An apparatus according to claim 1, characterised in that the stem part and/or the housing is designed to mix the medium flow.

3. An apparatus according to claim 1, characterised in that a sleeve member (7) is arranged to the apparatus, which sleeve member comprises at least a part of an abutment surface for the stem part (4).

4. An apparatus according to claim 1, characterised in that the sleeve member (7) is arranged to the housing to the outlet opening (3) or its vicinity.

5. An apparatus according to claim 1, characterised in that the sleeve member (7) comprises a surface (71, 72) which deflects the medium flow.

6. An apparatus according to claim 1, characterised in that the stem part (4) comprises a tip part (42) in the first end, on the side of the outlet.

7. An apparatus according to claim 1, characterised in that the stem part (4) comprises an extending part (41), which is most advantageously arranged in the stem part to the portion between the valve inlet (2) and the stem tip part (42).

8. An apparatus according to claim 1, characterised in that the sleeve member (7) is replaceable, whereby its design may be adapted according to the target of application.

9. An apparatus according to claim 1, characterised in that the sleeve member (7) is arranged to be fastened to the housing (1) together with an outlet pipe (6).
